(19) United States
(12) Patent Application Publication
(10) Pub. No.: US 2008/0164039 A1
(43) Pub. Date: Jul. 10, 2008

(54) Fire suppression gel delivery and truck cab protection systems

(75) Inventor: Gorden R. Sabo, Rapid City, SD (US)

Correspondence Address: GORDON & REES LLP, 101 WEST BROADWAY, SUITE 1600, SAN DIEGO, CA, 92101, US

(73) Assignee: DAKOTAFIRE SYSTEMS, INC., Rapid City, SD (US)

(21) Appl. No.: 12/001,800

(22) Filed: Dec. 13, 2007

Related U.S. Application Data
(60) Provisional application No. 61/000,376, filed on Oct. 25, 2007.
(60) Provisional application No. 60/906,991, filed on Mar. 14, 2007.
(60) Provisional application No. 60/875,754, filed on Dec. 19, 2006.

(51) Int. Cl. A62C 5/033; A62C 3/07; A62C 39/00

(52) U.S. Cl. 169/62; 169/15; 169/16

(57) ABSTRACT

A system for providing a fire suppression gel spray, including: a water tank; a water pump in fluid communication with the water tank; a gel tank; a gel pump in fluid communication with the gel tank; a spray nozzle in fluid communication with the water pump and the gel pump; a water flow control mounted on the spray nozzle; a gel flow control mounted on the spray nozzle; and a gel recirculation line for directing gel flow from the gel pump back into the gel tank, wherein the water flow control and the gel flow control are independently controllable at the spray nozzle. In addition, an optional system for spraying gel directly over the cab of a fire truck to which the present system is mounted is also included.

### RELATED APPLICATIONS

The present application claims priority to U.S. Provisional Patent Application Ser. No. 61/000,376, filed Oct. 25, 2007 entitled “Fire Suppression Gel Delivery and Truck Cab Protection Systems”; U.S. Provisional Patent Application Ser. No. 60/906,991, filed Mar. 14, 2007 entitled “Fire Suppression Gel Delivery System with Truck Cab Protection”; and Ser. No. 60/875,754, filed Dec. 19, 2006 entitled “Fire Suppression Gel Delivery System”. All patent applications are herein expressly incorporated by reference in their entirety for all purposes.

### TECHNICAL

The present invention relates to systems for spraying fire suppression gels that are used to fight forest fires.

### BACKGROUND OF THE INVENTION

Fire suppression gel spray systems are used for fighting forest fires. Typically, such gels are made of a fire retardant pellet material that expands in volume when water is added. When the gel has been mixed with water, it forms a viscous material that can be applied to various surfaces to provide fire protection. In operation, the resulting viscous mixture is sprayed over buildings and on the ground in the path of advancing forest fires.

The use of fire suppression gels allow fire firefighters to spray a building and then move away from the building as a forest fire approaches. This both protects the fire fighters and the buildings from the advancing fire. An advantage of such gel sprays is that firefighters are able to move through a neighborhood in advance of a fire, quickly spreading the fire suppression gel before the area becomes dangerous. In addition to spraying the fire suppression water/gel mix on buildings and structures, it is also possible to spray the water/gel mix directly on the ground and vegetation in the path of an advancing fire to provide a fire break. In addition, fire suppression gels can be sprayed on the exterior or interior of a burning building.

One significant problem fighting forest fires is that forest fires rapidly move up the sides mountains. Therefore, thus they must be fought under constantly changing altitudes and atmospheric pressure conditions. Unfortunately, existing gel spray systems for fighting forest fires do not operate well when quickly changing elevations. This is due to changes in atmospheric pressure affecting the composition and resultant viscosity of the fire suppression water/gel mix. In addition, it is particularly hard to operate many gel spray systems at high elevations, as the set mixture composition is more appropriate for lower altitudes (with higher air pressures).

Another disadvantage of existing fire suppression gel systems is that they tend to be bulky, and difficult to operate.

Yet another disadvantage of these systems is that they often offer poor, if any, protection to the firefighters themselves when they are fighting the fire, or when they are retreating from the fire.

### SUMMARY OF THE INVENTION

The present invention provides a system for providing a fire suppression gel spray, comprising: a water tank; a water pump in fluid communication with the water tank; a gel tank; a gel pump in fluid communication with the gel tank; a spray nozzle in fluid communication with the water pump and the gel pump; a water flow control mounted on the spray nozzle; and a gel flow control mounted on the spray nozzle, wherein the water flow control and the gel flow control are independently controllable. Most preferably, the independent control of the gel and water flows is provided by mechanisms at the spray nozzle itself.

In preferred aspects, a gel recirculation line is provided for directing gel flow out of the gel pump back into the gel tank. Thus, gel can be continuously re-circulated through the gel tank and the gel pump, whether or not gel is flowing out of the spray nozzle. As such, the gel pump operates whether or not gel is flowing out of the spray nozzle. A pressure relief valve may also be included in the gel recirculation line.

In further optional embodiments, an adjustable flow valve to selectively vary the percentages of gel flow into either the spray nozzle or the gel recirculation line may also be provided.

In further optional embodiments, the present system is mounted on a fire truck, and the present gel system is designed to protect the cab of the truck (and the firefighter(s) therein) by optionally applying fire suppression gel directly to the cab of the truck. This is particularly advantageous if the become surrounded by the forest fire, and are forced to take shelter in the truck cab.

In one embodiment, the truck cap protection system is connected to the water and gel tanks used for supplying the fire suppression gel spray to a forest fire. However, in another embodiment, the truck cap protection system is a separate free standing system that has its own water, air and gel tanks.

### BRIEF DESCRIPTION OF THE DRAWINGS

FIG. 1 is a schematic of a first embodiment of the invention.

FIG. 2 is a schematic of a second embodiment of the invention.

FIG. 3 is a schematic top down view of an optional embodiment of the invention in which the gel system is configured to protect a truck cab, by spraying fire suppression gel directly onto the fire truck cab.

FIG. 4 is a schematic of a second embodiment of the invention in which the gel system is configured to protect a truck cab, by spraying fire suppression gel directly onto the fire truck cab.

FIG. 5A is a schematic of a third embodiment of the invention in which the gel system is configured to protect a truck cab, by spraying fire suppression gel directly onto the fire truck cab.

FIG. 5B is a schematic of a fourth embodiment of the invention in which the gel system is configured to protect a truck cab, by spraying fire suppression gel directly onto the fire truck cab.

FIG. 6 is a schematic of a fifth embodiment of the invention in which the gel system is configured to protect a truck cab, by spraying fire suppression gel directly onto the fire truck cab.

### DETAILED DESCRIPTION OF THE DRAWINGS

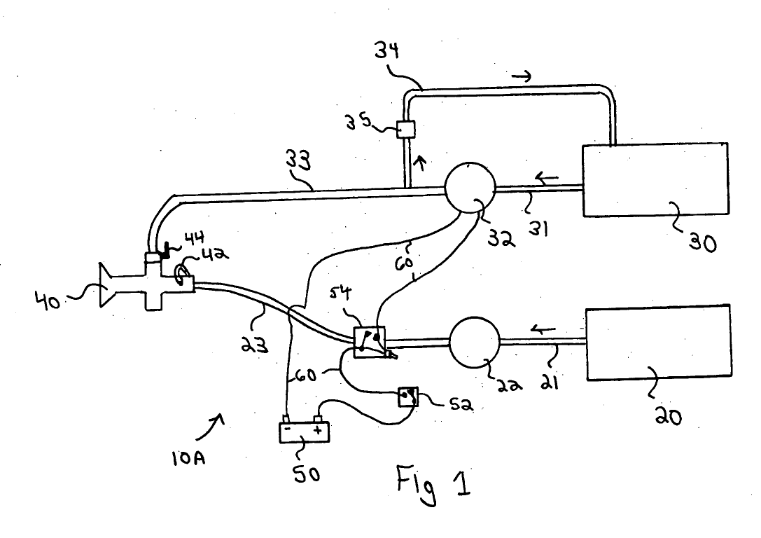

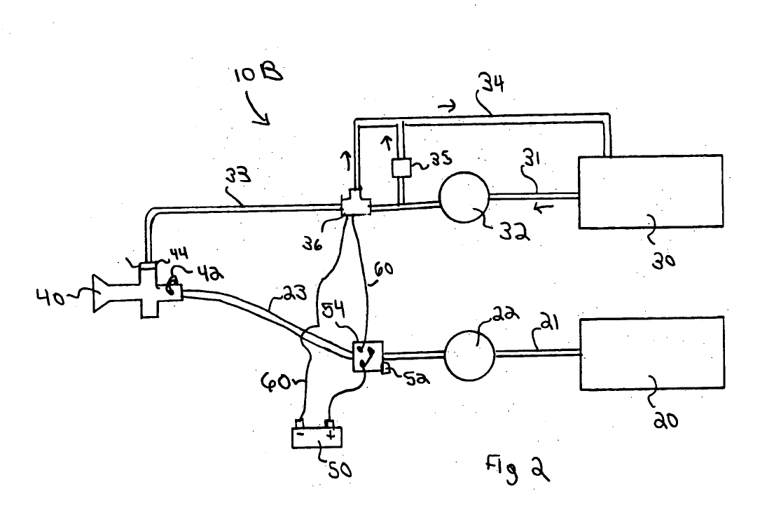

The present invention provides a system for providing a fire suppression gel spray. One embodiment of the invention (labelled system 10A) is seen in FIG. 1, and another embodiment (labelled 10B) is seen in FIG. 2. Each of these schematic Figs. include preferred dimensions for various system parts. It is to be understood that such dimensions are merely exemplary, and are not limiting in any way. Alternate embodiments and dimensions are also covered within the scope of the attached claims.

Systems 10A and 10B each include a water tank 20; a water pump 22 in fluid communication with water tank 20; a gel tank 30; a gel pump 32 in fluid communication with gel tank 30; a spray nozzle 40 in fluid communication with water pump 22 and gel pump 32; a water flow control 42 mounted on spray nozzle 40; and a gel flow control 44 mounted on spray nozzle 40. In system 10A, gel flow control 44 is a ¼ turn valve, and in system 10B, gel flow control 44 is a ½ inch turn valve. Other valve and flow control devices may also be used keeping within the scope of the present invention. Also, rotating levers may be used instead of rotating knob-type valves. Water pump 22 and gel pump 32 may be electric pumps, or gas or diesel pumps.

An advantage of the present invention is that the water flow control 42 and gel flow control 44 are independently controllable. As such, and operator can turn either control partially on, or fully on, or off independently of one another. Thus, the operator can adjust both: (1) the total volume of the water/gel mixture being sprayed, and (2) the relative concentrations of each of the water and the gel within the mixture.

This feature of the invention is very advantageous in many regards.

First, it allows the operator to rapidly adjust optimal flow mixture at different altitudes. For example, a greater percentage of gel may be used at higher altitudes (where lower air pressure would otherwise result in decreased viscosity of the water/gel mixture).

Secondly, an operator can easily apply more the water/gel mixture to a particular building or structure, while tapering off the flow to use less water/gel mixture on the ground, as needed.

Thirdly, an operator can select to flow only water or gel. This may be necessary when using water to fill a small portable external water tank, or when using gel to fill a small portable external gel tank.

As can be seen in FIGS. 1 and 2, gel flow line 31 connects gel tank 30 to gel pump 32, and gel flow line 33 connects gel pump 32 to spray nozzle 40. Similarly, water flow line 21 connects water tank 20 to water pump 22, and water flow line 23 connects water pump 22 to spray nozzle 40. Lines 21, 23, 31 and 33 (and 34) may be standard plastic hoses, including plastic garden hoses.

As can also be seen in FIGS. 1 and 2, systems 10A and 10B include a gel recirculation line 34 for directing gel flow from gel pump 32 back into gel tank 30. As such, gel can be continuously re-circulated through gel tank 30 and gel pump 32, whether or not gel is flowing out of spray nozzle 40. Re-circulating the gel has the advantage of mixing the gel such that it is easier to spray (as compared to existing non-recirculating on/off gel pump systems). In addition, a sufficient back pressure can be maintained by recirculating the gel (because the gel pump 32 remains on). In contrast, pre-existing systems relied upon turning a gel pump on and off. Thus resulted in changes (i.e.: periodic drops) of pressure in the gel flow lines, changing the composition of the water/gel mixture over time, and/or further complicating the percentage setting of the water/gel mixture. As such, gel pump 32 operates whether or not gel is flowing out of spray nozzle 40, whereas water pump 22 operates only when water is flowing out of spray nozzle 40. Optionally, a pressure relief valve 35 may also be included in the gel recirculation line, to guard against excessive back pressures building up in the gel lines.

Systems 10A and 10B can both be powered by a single battery 50. An on/off switch 52 that controls flow switch 54 is also provided. In system 10A (FIG. 1), flow switch 54 turns on gel pump 32 (Note: wires are labelled as 60 is FIGS. 1 and 2). In contrast, in system 10B, flow switch 54 controls the settings of adjustable flow valve 36. Adjustable flow valve 36 is used to selectively vary the percentages of gel flow passing into either spray nozzle 40 (through line 33) or into gel recirculation line 34. Thus, adjustable flow valve 36 can be used to selectively “bleed off” gel that is being re-circulated. Moreover, the combined effect of adjustable flow valve 36 and pressure relief valve 35 can be used to maintain optimal gel pressures regardless of the particular amount of gel being sprayed out of nozzle 40 at any particular time.

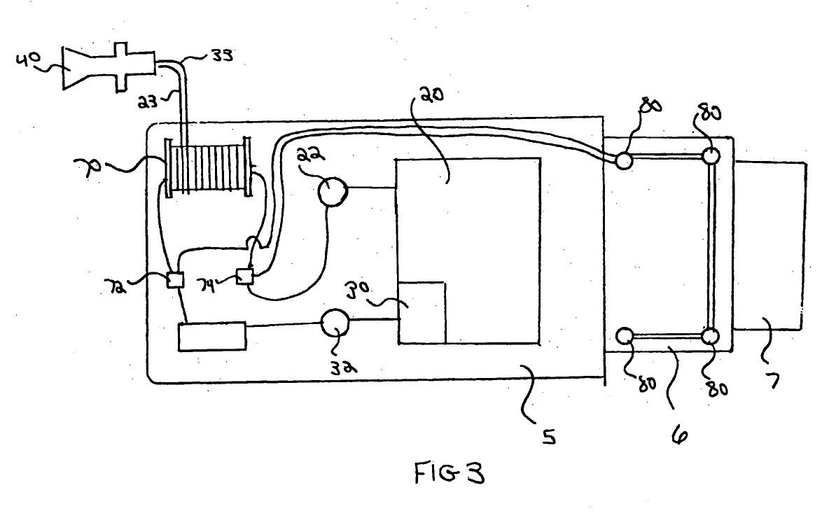

In optional embodiments, water tank 20 may be mounted in a motor vehicle (as shown in the attached photos) and in FIG. 3, as follows.

FIG. 3 is a top view of fire truck 5. Water tank 20, water pump 22, gel tank 30 and gel pump 32 are mounted onto the back of truck 5. Spray nozzle 40, lines 23 and 33 are also shown. Preferably, lines 23 and 33 are wrapped around a large reel 70 such that extra length of these lines can be conveniently rolled up and stored. Truck 5 has a cab 6 and a front hood 7.

In optional embodiments, one or more gel spraying nozzles 80 are mounted onto cab 6. Gel nozzles 80 preferably face upwardly and are designed to shower cab 6 (and the area surrounding cab 6) with fire suppression gel when activated. Preferably, gel nozzles 80 are powerful enough to spray gel not only over a large portion of truck 5, but also over the surrounding ground area. Thus, when activated, fire fighters can take refuge in cab 6 when cab 6 has been showered with fire suppression gel. Nozzles 80 spray gel over cab 6 when valves 72 and 74 have been activated to direct gel towards nozzles 80. Specifically, valve 72 directs gel towards nozzles 80, and valve 74 directs water towards nozzles 80. A control or activation switch or pull lever can be used to switch valves 72 and 74 to immediately spray a gel/water solution through nozzles 80.

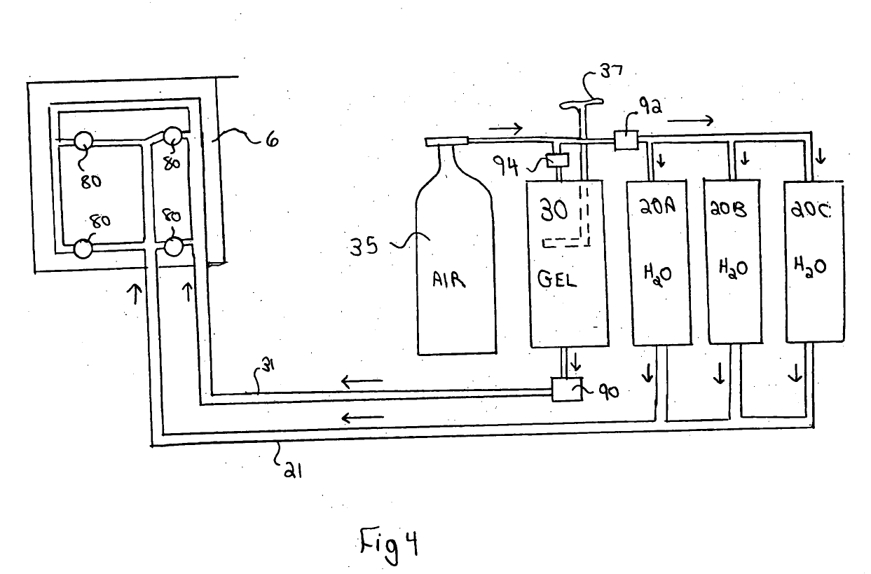

FIG. 4 shows an alternate embodiment of the system mounted onto a truck cab 6, similar to the system of FIG. 3, as follows. Gel nozzles 80 are similarly mounted upwardly to shower cab 6 (and the area surrounding cab 6) with fire suppression gel when activated. In this embodiment, however, a plurality of water tanks 20A, 20B and 20C are used. A single gel tank 30 is used. It is to be understood, however, that the present invention is not limited to any particular number of water and gel tanks. In the present embodiment, a pressurized air tank 35 is also included. In accordance with the present invention, pressurized gases or gas mixtures other than air can instead be used in tank 35.

In accordance with the embodiment of the invention shown in FIG. 4, the truck cab protection system is a separate free standing system. When activated, the compressed air from tank 35 enters the top of gel tank 30, thus pushing the gel through lines 31 towards nozzles 80. Similarly, the compressed air from tank 35 enters the top of water tanks 20A, 20B and 20C, thus pushing the water out of the bottom of tanks and through lines 21 towards nozzles 80. In FIGS. 4 to 6, the flow directions are shown by arrows. The gel (from tank 30) is mixed with the water (from tanks 20A, 20B and 20C) in nozzles 80, thus producing a fire suppressing gel mixture that is sprayed from nozzles 80 over truck cab 6. At this time, the firefighters are able to take shelter therein). The compressed air in air tank 35 operates as the propellant forcing the gel/water mixture out of nozzles 80. Preferably, nozzles 80 are located at the 4 corners of the truck cab. However, the present invention is not so limited. For example, more than four nozzles may be used. For example, when an entire vehicle (or a large portion thereof) is sprayed by the nozzles.

In operation, a power source (which may be a simple 12V source, not shown) is used to open solenoid valves 90 and 94 (thus permitting gel to flow from tank 35 through lines 31 towards nozzles 80). Note, solenoid valve 90 is optional since gel flow out of tank 30 may instead be controlled by a single valve 94 at the top of tank 30 instead. Another flow valve and/or regulator 92 controls the entry of air from tank 35 into water tanks 20A, 20B and 20C. By pre-adjusting valves 90, 92 and 94, an optimal flow of gel/water mixture will spray out of nozzles 80. Thus, when these valves are switched on, the system immediately sprays a fire suppression gel/water mixture over cab 6.

An advantage of this system is that (by using compressed air in tank 35 as the propellant), the need for pumps to spray the gel/water mixture over cab 6 is avoided. As such, this embodiment operates as a stand-alone unit. All that is required to turn on and operate the system is a simple voltage load (e.g.: a 12V system). As such, this system can be used by vehicles that are not equipped to fight forest fires by spraying fire suppression gels at all. For example, the system can be used on an equipment transportation truck, as opposed to a fire truck.

Gel tank 30 optionally comprises a stirring plunger 37. Stirring plunger 37 is used to ensure that the gel in tank 35 does not “settle” over time and separating due to gravity. As such, stirring plunger 37 can be manually pumped up and down to stir the interior contents of tank 35 several times a year, or months to ensure that the gel is stirred prior to potential operation of the system.

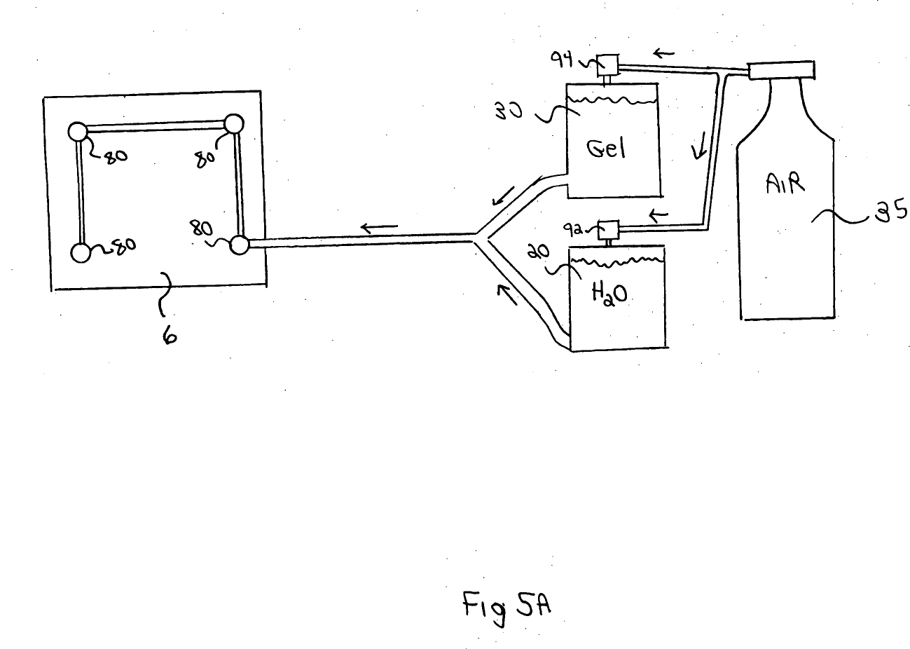

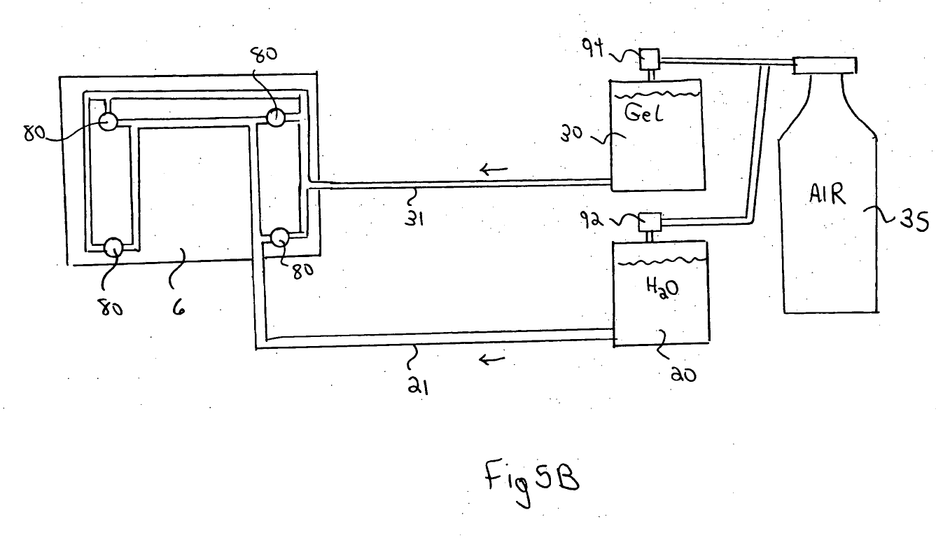

FIG. 5A shows an alternate embodiment of the stand alone truck cab protection system. In this embodiment, compressed air from tank 35 passes through valve 94 into the top of gel tank 30, thus forcing the gel out of the bottom of tank 30. Similarly, compressed air from tank 35 passes through valve 92 into the top of water tank 20, thus forcing the water out of the bottom of tank 20. The water and gel then mix together in a common flow line heading to nozzles 80 on truck cab 6. An advantage of this system is that only a single flow line to nozzles 80 is required.

FIG. 5B is similar to FIG. 5A, but instead uses separate flow lines for each of the water and the gel reaching the nozzles 80.

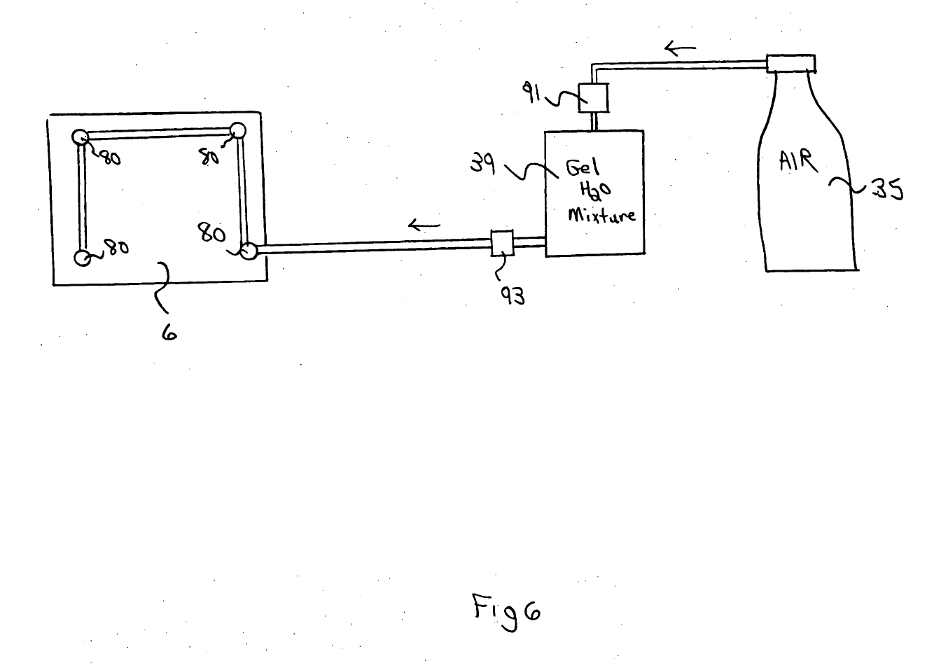

FIG. 6 shows yet another alternate embodiment of the stand alone truck cab protection system. In this embodiment, compressed air from tank 35 passes through valve 91 into tank 39 which contains a pre-mixed gel/water mixture. As compressed air enters the top of tank 39, the gel/water mixture is forced out of the bottom of tank 30, heading through a common flow line towards nozzles 80 on truck cab 6. An additional valve 93 is provided to seal flow from the bottom of tank 39. When both valves 91 and 93 are closed, tank 39 can be removed and replaced for system maintenance. An advantage of this system is that only a single flow line to nozzles 80 is required.

The fire suppressing gel used in the present invention may be any liquid form of fire suppressing gel, including, but not limited to, Thermo Gel 200L, manufactured by Thermo-Gel Technologies, of Bismarck, N. Dak.

What is claimed is:

1. A system for providing a fire suppression gel spray, comprising:
a water tank;
a water pump in fluid communication with the water tank;
a gel tank;
a gel pump in fluid communication with the gel tank;
a spray nozzle in fluid communication with the water pump and the gel pump;
a water flow control mounted on the spray nozzle; and
a gel flow control mounted on the spray nozzle, wherein the water flow control and the gel flow control are independently controllable.

2. The system of claim 1, wherein gel flow lines connect the gel tank to the gel pump, and the gel pump to the spray nozzle; and wherein water flow lines connect the water tank to the water pump, and the water pump to the spray nozzle.

3. The system of claim 2, further comprising:
a gel recirculation line for directing gel flow from the gel pump back into the gel tank.

4. The system of claim 3, further comprising:
a pressure relief valve in the gel recirculation line.

5. The system of claim 3, wherein gel continuously re-circulates through the gel tank and the gel pump, whether or not gel is flowing out of the spray nozzle.

6. The system of claim 3, wherein the gel pump operates whether or not gel is flowing out of the spray nozzle.

7. The system of claim 3, wherein the water pump operates only when water is flowing out of the spray nozzle.

8. The system of claim 3, further comprising:
an adjustable flow valve to selectively vary the percentages of gel flow into either the spray nozzle or the gel recirculation line.

9. The system of claim 1, wherein the water flow control is a rotatable control lever.

10. The system of claim 1, wherein the gel flow control is a rotatable control valve.

11. The system of claim 1, further comprising:
a truck body onto which the water tank, water pump, gel tank, and gel pump are mounted.

12. The system of claim 11, further comprising:
a plurality of gel spray nozzles mounted onto the truck body for spraying gel over the truck body.

13. The system of claim 12, wherein:
the plurality of gel spray nozzles comprise four upwardly spraying nozzles, each mounted near a corner of a driver's cab of the truck body.

14. A system for providing a fire suppression gel spray to the driver's cab of the truck body, comprising:
a pressurized gas tank;
a gel tank in communication with the pressurized gas tank, and separated by a gel tank valve;
at least one water tank in communication with the pressurized gas tank, and separated by a water tank valve;
a plurality of gel spray nozzles in communication with the gas tank, the gel tank and the at least one water tank, wherein pressure from the pressurized gas tank forces gel from the gel tank and water from the at least one water tank out of the plurality of gel spray nozzles when the gel tank valve and the water tank valves are opened.

15. The system of claim 14, wherein the plurality of gel spray nozzles are mounted to a truck cab.

16. A system for providing a fire suppression gel spray to the driver's cab of the truck body, comprising:
a pressurized gas tank;
a combined gel and water tank in communication with the pressurized gas tank, and separated by a valve; and
a plurality of gel spray nozzles in communication with the gas tank and the combined gel and water tank, wherein pressure from the pressurized gas tank forces a combined gel/water mixture from the combined gel and water tank out of the plurality of gel spray nozzles when the valve is opened.

17. The system of claim 16, wherein the plurality of gel spray nozzles are mounted to a truck cab.
